(19) United States
(12) Patent Application Publication
(10) Pub. No.: US 2026/0370509 A1
(43) Pub. Date: Nov. 19, 2026

(54) ONBOARDING A HOUSEHOLD APPLIANCE TO A NETWORK WITH THE ASSISTANCE OF A HOUSEHOLD APPLIANCE CONNECTED TO THE NETWORK

(71) Applicant: ELECTROLUX APPLIANCES AKTIEBOLAG, Stockholm (SE)

(72) Inventors: Livio PLOS, Porcia (IT); Giovanni TIANO, Porcia (IT)

(73) Assignee: ELECTROLUX APPLIANCES AKTIEBOLAG, Stockholm (SE)

(21) Appl. No.: 19/135,555

(22) PCT Filed: Sep. 20, 2023
(86) PCT No.: PCT/EP2023/075896

§ 371 Date: Jun. 4, 2025

(30) Foreign Application Priority Data
Dec. 7, 2022 (GB) 2218412.1

(51) Int. Cl. H04L 12/28; H04L 9/08; H04L 9/32

(52) U.S. Cl. CPC H04L 12/2803; H04L 9/0825; H04L 9/3271; H04L 2012/2841; H04L 2012/285

(57) ABSTRACT

A system may allow an onboarding household appliance to automatically onboard to a wireless local area network with the assistance of an assisting household appliance already connected to the network. The assisting household appliance is configured to store network connection credentials, by means of which the assisting household appliance may be connected to the network. The assisting household appliance may be configured to receive an onboarding request from the onboarding household appliance containing a unique identifier of the onboarding household appliance and authenticate the onboarding household appliance based on the unique identifier in the received onboarding request. The assisting household appliance may be configured to, when the onboarding household appliance is authenticated, provide the network connection credentials to the onboarding household appliance. The onboarding household appliance is configured to receive the network connection credentials from the assisting household appliance and connect to the network using the received network connection credentials.

### TECHNICAL FIELD OF THE INVENTION

The present invention relates, in general, to household appliances, e.g., washing machines, dishwashers, ovens, etcetera, in particular to smart electrical household appliances, also known as network-connectable or Internet-of-Things (IoT) electrical household appliances, i.e. electrical household or domestic appliances provided with wireless communication interfaces designed to allow the household appliances to connect to a network, to which further smart household appliances are connected.

In particular, the present invention relates to onboarding a smart household appliance to a communication network by leveraging on smart household appliances which are already connected to the network and which securely share their network connection credentials with the household appliance to be onboarded.

### BACKGROUND OF THE INVENTION

As is known, household appliances are getting everyday more and more connected to the Internet to deliver new services to customers. A challenge of having a household appliance connected and ready to work is called onboarding, provisioning or network set up and it consists in either one or both of connecting the household appliance to the wireless local area network (e.g., the Wi-Fi network of the house of a customer) and associating the household appliance with a customer's account.

The simplest way of onboarding a household appliance to a network, typically a WLAN, is to leverage on household appliances which are already connected to the network and which share their network connection credentials with the connecting smart household appliance.

Sharing of the network connection needs to be carried out by safeguarding confidentially of the network connection. Broadcasting is unsafe since anyone listening can make use of such credentials. Sharing a secret among involved household appliances is also a source of complexity for inexperienced or unexperienced customers. A company or an association sharing the principle of using the credentials without giving any user the access and supporting further sharing requires a method to verify when the onboarding household appliance, without the network connection, is trustable, i.e., belongs to the same company or association domain and is reliable, before sharing the secrets.

In order to complete the onboarding procedure of a household appliance to a WLAN, the customer must know the WLAN settings and/or the customer's account details and follow a certain sequence of steps which may be confusing or too complex for some inexperienced or unexperienced customers.

Furthermore, in recent years, customers demand the household appliances to automatically connect to their smart devices, such as smartphones or tablets, on which a software application (app) is installed, which is designed to allow the customers to easily manage operation of the household appliances.

### OBJECT AND SUMMARY OF THE INVENTION

The Applicant has noted the importance of protecting WLAN credentials shared for onboarding smart household appliances, and preventing malicious users to connect to private WLANs, such as customers' WLANs to which smart appliances are connected, where sensitive applications can be installed.

Thus, an object of the present invention is to provide a technology that allows smart household appliances to automatically and securely connect to WLANs by exploiting network connection credentials shared by household appliances already connected to the same WLANs. Therefore, the present invention relates to a system and a method for allowing a smart household appliance to automatically connect to a wireless local area network, as claimed in the appended claims.

In particular, according to a first aspect thereof, the present invention relates to a system for allowing a first household appliance to automatically onboard to a network with the assistance of a second household appliance connected to the network, wherein the second household appliance is configured to:
store network connection credentials, by means of which the second household appliance connected to the network;
receive an onboarding assistance request from the first household appliance and containing a unique identifier of the first household appliance;
authenticate the first household appliance based on the unique identifier in the received onboarding assistance request; and
when the first household appliance is authenticated, provide the network connection credentials to the first household appliance;
and the first household appliance is configured to:
broadcast an onboarding request;
receive the network connection credentials from the second household appliance; and
connect to the network using the received network connection credentials.

In order to authenticate the first household appliance, the second household appliance is further configured to:
retrieve a public cryptographic key of the first household appliance; and
authenticate the onboarding household appliance based on the public cryptographic key of the first household appliance and an asymmetric cryptography authentication protocol.

In one possible embodiment, in order to authenticate the first household appliance, the second household appliance is further configured to:
access a public cryptographic key database where public cryptographic keys of household appliances are stored in association with unique identifiers thereof to fetch out from the public cryptographic key database the public cryptographic key of the first household appliance stored in association with the unique identifier thereof; and
authenticate the first household appliance based on the public cryptographic key thereof fetched out from the public cryptographic key database and on the asymmetric cryptography authentication protocol.

In another possible embodiment, in order to authenticate the first household appliance, the second household appliance is further configured to:
access a public cryptographic key database where values computed from public cryptographic keys of household appliances based on a one-way function that converts the public cryptographic keys to values representative of the public cryptographic keys, conveniently hashes thereof, are stored in association with unique identifiers of the household appliances, to fetch out from the public cryptographic key database the value computed from the public cryptographic key of the first household appliance and stored in association with the unique identifier thereof;
communicate with the first household appliance to receive therefrom a stored public cryptographic key of the first household appliance;
compute a value from the public cryptographic key received from the first household appliance and based on the same one-way function based on which the value fetched out from the public cryptographic key database and stored in association with the unique identifier of the first household appliance was computed from the public cryptographic key thereof;
check whether the value fetched out from the public cryptographic key database matches with the value computed from the public cryptographic key of the first household received therefrom;
if the stored value fetched out from the public cryptographic key database is determined to match with the computed value computed from the public cryptographic key of the first household received therefrom, authenticate the first household appliance based on the public cryptographic key thereof received therefrom and on the asymmetric cryptography authentication protocol.

The public cryptographic key database is preferably a cryptographic key database.

Preferably, the second household appliance is configured to authenticate the first household appliance based on an asymmetric cryptography challenge-response authentication protocol.

In one possible embodiment, according to the asymmetric cryptography challenge-response authentication protocol, the second household appliance is configured to:
generate a challenge for the first household appliance;
encrypt the challenge with the public cryptographic key of the first household appliance;
send the encrypted challenge to the first household appliance;
receive a response from the first household appliance;
check whether the received response to the challenge is valid; and
authenticate the first household appliance if the received response to the challenge is determined to be valid;
and the first household appliance is configured to:
receive the encrypted challenge;
decrypt the encrypted challenge using its cryptographic private key;
compute and send a response to the second household appliance.

In one possible embodiment, the onboarding assistance request may be broadcasted by the first household appliance in response to detecting an assistance availability advertisement broadcasted by the second household appliance and advertising its availability to assist the first household appliance in onboarding to the network.

In another possible embodiment, the onboarding assistance request may be broadcasted by the first household appliance in response to receiving an onboarding trigger command from a customer's mobile terminal in communication with the first household appliance.

The onboarding trigger command may be generated by the customer's mobile terminal in response to either a customer's trigger gesture on the customer's mobile terminal or a customer-uttered trigger voice command.

In one embodiment, the second household appliance may be configured to become authorized to assist the first household appliance in onboarding to the network by an onboarding authorization command received from one of or both a control panel of the second household appliance and a customer's mobile terminal directly or indirectly connected to the second household appliance.

In another possible embodiment, the second household appliance may be configured to become authorized to assist the first household appliance in onboarding to the network by an onboarding authorization command received from either a seller of the first household appliance or a cloud system and generated in response to the first household appliance being registered to a customer's account.

According to another aspect thereof, the present invention relates to software modules loadable in a first household appliance to be onboarded to a network and in a second household appliance already connected to the network; the software modules are designed to cause, when executed by the first and second household appliances, the first and second household appliances to become configured to cooperate to cause the first household appliance to automatically onboard to the network with the assistance of the second household appliance already connected to the network according to the above system.

The present invention is also related to a method for onboarding a household appliance to a network, comprising the steps of:
broadcasting, by a first household appliance, an onboarding assistance request containing a unique identifier of the first household appliance;

receiving, in a second household appliance, the onboarding assistance request;
retrieving, by the second household appliance, a public cryptographic key of the first household appliance based on said unique identifier;
authenticating, in the second household appliance, the first household appliance based on said public cryptographic key and on an asymmetric cryptography authentication protocol; after authenticating the first household appliance, sending network connection credentials of the second household appliance to the first household appliance; and
connecting the first household appliance to the network using the network connection credentials of the second household appliance.

The public cryptographic key database is preferably a trusted cryptographic key database.

The network connection credentials of the second household appliance are advantageously sent to the first household appliance by the second household appliance.

In one possible embodiment, the step of retrieving a public cryptographic key of the first household appliance comprises the following steps:
accessing, by the second household appliance, a public cryptographic key database where public cryptographic keys of household appliances are stored in association with unique identifiers thereof, and
identifying, in the public cryptographic key database, the public cryptographic key associated with said unique identifier of the first household appliance.

In another possible embodiment, the step of retrieving a public cryptographic key of the first household appliance comprises the following steps:
accessing, by the second household appliance, a public cryptographic key database where values computed from public cryptographic keys of household appliances based on a one-way function are stored in association with unique identifiers of the household appliances, and
identifying in said database a first value computed from the public cryptographic key of the first household appliance;
and authenticating the first household appliance comprises:
sending from the first household appliance to the second household appliance a public cryptographic key of the first household appliance;
computing, in the second household appliance, a second value from the public cryptographic key received from the first household appliance based on said one-way function;
checking whether the first value matches with the second value;
if the first value matches with the second value, authenticating the first household appliance based on the public cryptographic key received therefrom and on the asymmetric cryptography authentication protocol.

Advantageously, the public cryptographic key of the first household appliance sent from the first household appliance to the second household appliance is stored in the first household appliance.

### BRIEF DESCRIPTION OF THE DRAWINGS

FIG. 1 shows a block diagram of a system for allowing a smart household appliance to automatically onboard to a network according to the present invention.

FIGS. 2 to 5 show block diagrams of the operation of the system shown in FIG. 1.

### DESCRIPTION OF EMBODIMENTS OF THE INVENTION

The present invention will now be described in detail with reference to the attached figures to allow a skilled person to make and use it. Various modifications to the embodiments described will be immediately apparent to skilled person and the generic principles described can be applied to other embodiments and applications without thereby departing from the scope of the present invention, as defined in the attached claims. Therefore, the present invention should not be considered limited to the embodiments described and illustrated herein, but should be accorded the broadest scope of protection consistent with the described and claimed features.

Unless otherwise defined, all technical and scientific terms used herein have the same meaning commonly used by persons of ordinary experience in the field pertaining to the present invention. In the event of a conflict, this description, including the definitions provided, will be binding. Furthermore, the examples are provided for illustrative purposes only and as such should not be regarded as limiting.

In particular, the block diagrams included in the attached figures and described below are not intended as a representation of the structural characteristics, or constructive limitations, but must be interpreted as a representation of functional characteristics, i.e., intrinsic properties of the devices and defined by the effects obtained or functional limitations and which can be implemented in different ways, therefore in order to protect the functionality of the same (possibility of functioning).

In order to facilitate the understanding of the embodiments described herein, reference will be made to some specific embodiments and a specific language will be used to describe them. The terminology used herein has the purpose of describing only a particular embodiment and is not intended to limit the scope of the present invention.

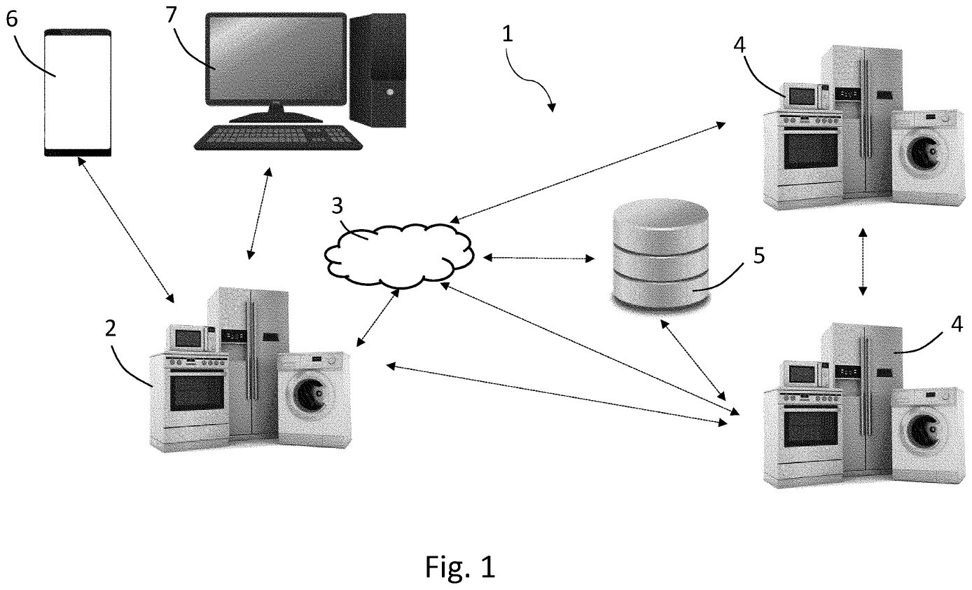

FIG. 1 shows a system 1 for allowing a first smart household appliance 2 to automatically onboard to a communication network 3 with the assistance of a second smart household appliance 4 already connected to the network 3.

In the rest of the present description, the first smart household appliance 2, i.e., the one to be onboarded, will be referred to as “onboarding household appliance”, while the second smart household appliance 4, i.e., the one already connected to the network 3, will be referred to as “assisting household appliance”.

The network 3 may be based on any wired or wireless computer network technologies, in particular a wired local area network (LAN), such as Ethernet, a wireless local area network (WLAN), such as Wi-Fi network or a BLE (Bluetooth Low Energy) network. Without losing any generality, the following description will refer to a WLAN network.

In order to be able to connect to the network 3, the onboarding household appliance 2 and the assisting household appliance 4 are provided with respective network controllers. In one embodiment, the onboarding household appliance 2 and the assisting household appliance 4 are WLAN-enabled and are provided with respective WLAN controllers. In a different embodiment, the onboarding household appliance 2 and the assisting household appliance 4 may be also BLE-enabled and are provided with respective BLE network controllers.

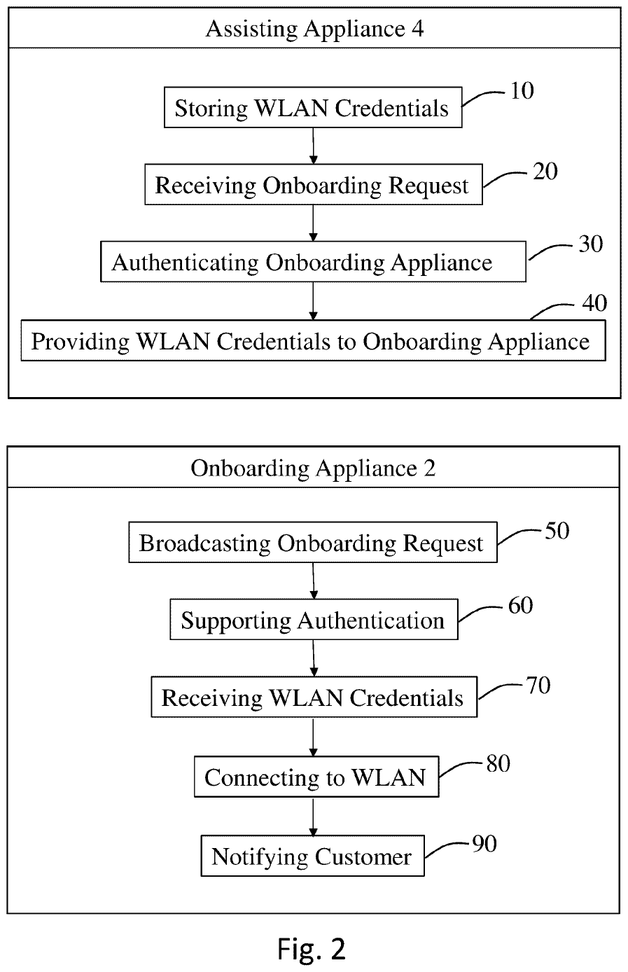

As shown in FIG. 2, in order to assist the onboarding household appliance 2 in onboarding to the WLAN 3, the assisting household appliance 4 is programmed to:
store WLAN credentials, by means of which the assisting household appliance 4 connected to the WLAN 3 (block 10);
detect an onboarding assistance request broadcasted by the onboarding household appliance 2 and containing a unique identifier of the onboarding household appliance 2, in the embodiments considered the MAC address of the WLAN/BLE controller of the onboarding household appliance 2 (block 20);
in response to detecting the onboarding assistance request broadcasted by the onboarding household appliance 2, authenticate the onboarding household appliance 2 based on the unique identifier in the received onboarding request (block 30) and according to an asymmetric cryptography authentication protocol, also known as asymmetric key encryption, conveniently, but not necessarily, an asymmetric cryptography challenge-response authentication protocol, which will be described below; and
when the onboarding household appliance 2 is authenticated, provide the WLAN credentials to the onboarding household appliance 2 (block 40).

The onboarding household appliance 2 is consequently programmed to:
advertise its need to be assisted in onboarding to the WLAN 3 by broadcasting the onboarding assistance request, e.g., after power up (block 50);
support the asymmetric cryptography authentication protocol and cooperate with the assisting household appliance 4 in being authenticated by the latter based on the asymmetric cryptography authentication protocol (block 60);
receive the WLAN credentials from the assisting household appliance 4 (block 70);
connect to the WLAN 3 using the received WLAN credentials (block 80); and
notify the customer of the successful onboarding to the WLAN 3 (block 90).

In one embodiment, the onboarding assistance request is broadcasted by the onboarding household appliance 2 in response to detecting an assistance availability advertisement broadcasted by the assisting household appliance 4 and advertising its availability to assist the onboarding household appliance 2 in onboarding to the WLAN 3.

To do so, the assisting household appliance 4 is programmed to advertise its availability to assist the onboarding household appliance 2 in onboarding to the WLAN 3 by broadcasting the assistance availability advertisement, and the onboarding household appliance 2 is programmed to detect the assistance availability advertisement broadcasted by the assisting household appliance 4 and responsively broadcast the onboarding assistance request.

Conveniently, the assistance availability advertisement may be advertised by the assisting household appliance 4 exploiting the BLE e-beacon functionality, according to which the BLE interface by the assisting household appliance 4 may be caused to operate as a BLE e-beacon device, i.e., to broadcast an advertising signal containing the assistance availability advertisement and intended to be received by BLE-enabled devices.

In a different embodiment, the onboarding assistance request is broadcasted by the onboarding household appliance 2 in response to receiving an onboarding trigger command from a customer's mobile terminal 6, such as a smartphone or a tablet, in communication with the onboarding household appliance 4, conveniently via a short-range wireless communication technology, e.g., the Wi-Fi or Bluetooth technology.

The onboarding trigger command may be generated by the customer's mobile terminal 6 in response to a customer's trigger gesture on the customer's mobile terminal 6, where a mobile application is installed and executed that is designed to allow the customer to trigger the onboarding of the onboarding household appliance 2 by means of a gesture, e.g., by tapping an “add device” button that responsively causes an “add device” function to be selected and performed.

The onboarding trigger may be generated by the customer's mobile terminal 6 also in response to a customer-uttered trigger voice command.

In an exemplary embodiment in which a plurality of assisting household appliances 4 are already connected to the WLAN 3, the mobile application may be designed to cause the onboarding trigger command to be transmitted to a cloud system (not shown) which retransmits the onboarding trigger command to all the costumer's household appliances 4.

In this embodiment, in response to detecting the onboarding assistance request broadcasted by the onboarding household appliance 2, the assisting household appliance 4 is programmed to notify the onboarding household appliance 2 of its availability to assist the onboarding household appliance 2 in onboarding to the WLAN 3 and the onboarding household appliance 2 is programmed to notify the assisting household appliance 4 of acceptance of the assistance of the assisting household appliance 4 in onboarding to the WLAN 3.

To do so, in response to detecting the onboarding request from the onboarding household appliance 2, the assisting household appliance 4 is programmed to either send a connectionless message to, or establish a connection with, the onboarding household appliance 2, while the onboarding household appliance 2 is consequently programmed to responsively either receive a connectionless message from, or establish a connection with, the assisting household appliance 4 and responsively broadcast the onboarding request.

In one embodiment, the onboarding household appliance 2 is programmed to broadcast the onboarding assistance request by creating either a Wi-Fi or a BLE (Bluetooth Low Energy) network and broadcast either the Wi-Fi SSID (Service Set Identifier) or the BLE network name (predefined name structure or fixed name) containing the unique identifier of the onboarding household appliance 2, in particular the MAC address of the WLAN/BLE controller of the onboarding household appliance 2.

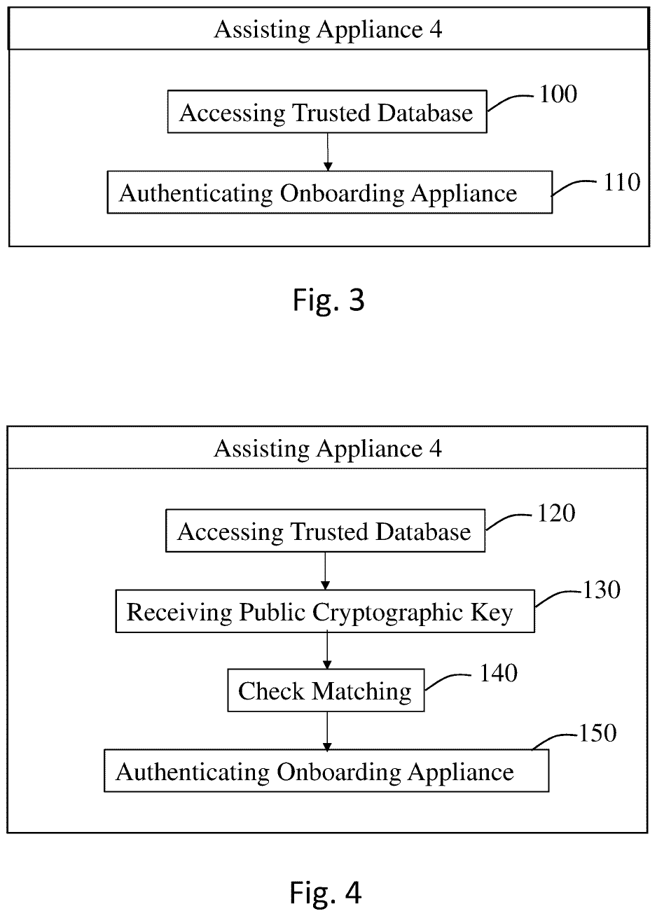

In one embodiment shown in FIG. 3, in order to authenticate the onboarding household appliance 2, the assisting household appliance 4 is programmed to:
access a public cryptographic key database 5 (connected to the WLAN either locally or remotely via a cloud connection) where public cryptographic keys of household appliances are stored in association with the unique identifiers of the household appliances contained in the onboarding request to fetch out from the public cryptographic key database 5 the public cryptographic key of the onboarding household appliance 2 stored in association with the unique identifier thereof (block 100);
authenticate the onboarding household appliance 2 based on the public cryptographic key of the onboarding household appliance 2 fetched out from the database 5 and on the asymmetric cryptography authentication protocol (block 110).

In a different embodiment shown in FIG. 4, in order to authenticate the onboarding household appliance 2, the assisting household appliance 4 is instead programmed to:
access a public cryptographic key database 5 (connected to the WLAN either locally or remotely via a cloud connection) hashes of public cryptographic keys, i.e., values computed from the public cryptographic keys and a fit-for-purpose cryptographic hash function (CHF), of household appliances are stored in association with the unique identifiers of the household appliances to fetch out from the public cryptographic key database 5 the hash of the public cryptographic key of the onboarding household appliance 2 stored in association with the unique identifier thereof (block 120);
communicate with the onboarding household appliance 2 to receive therefrom its own stored public cryptographic key and compute the hash of the received public cryptographic key (block 130);
check whether the hash of the public cryptographic key of the onboarding household appliance 2 computed based on the public cryptographic key of the onboarding household appliance 2 received therefrom matches with the hash of the public cryptographic key of the onboarding household appliance 2 fetched out from the public cryptographic key database 5 (block 140);
if hashes of the public cryptographic keys of the onboarding household appliance 2 are determined to match, authenticate the onboarding household appliance 2 based on the public cryptographic key of the onboarding household appliance 2 and on the predetermined authentication protocol (block 150).

At the end of this process, the onboarding household appliance 2 has been verified for authenticity, i.e., its identity has been proven as part of the company devices or authorized by an organization and it has not been revoked.

It goes without saying that the public cryptographic key database 5 could store, in place of the hashes of the public cryptographic keys of the household appliances, any other equivalent values computed from the public cryptographic keys of the household appliances based on any one-way functions that convert or map the public cryptographic keys into fixed-length strings or values representative of the public cryptographic keys, based on any fit-for-purpose mathematical conversion algorithm.

In the different embodiments described above, the public cryptographic key database is advantageously a trusted cryptographic key database.

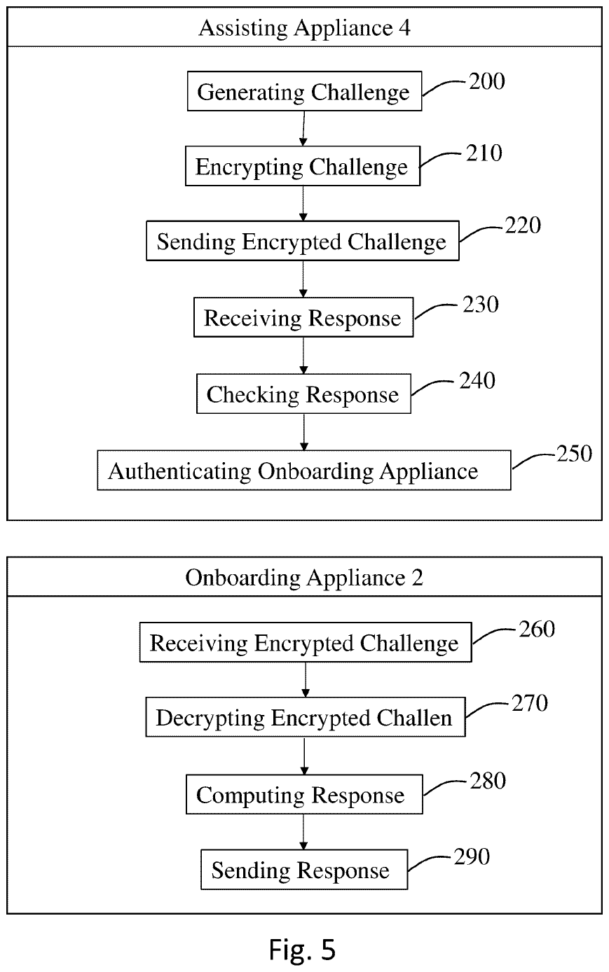

As previously said, the assisting household appliance 4 is programmed to authenticate the onboarding household appliance 2 conveniently, but not necessarily, based on an asymmetric cryptography authentication protocol, conveniently an asymmetric cryptography challenge-response authentication protocol, a block diagram of which is shown in FIG. 5.

To cryptographically challenge-response authenticate the onboarding household appliance 2:
the assisting household appliance 4 is programmed to:
   generate a challenge (question) for the onboarding household appliance 2 (block 200);
   encrypt the challenge with the cryptographic public key of the onboarding household appliance 2, either the one fetched out from the trusted database 5, in the first embodiment described above, or the one received from the onboarding household appliance 2, in the second embodiment describe above (block 210);
   send the encrypted challenge to the onboarding household appliance 2 (block 220);
   receive a response from the onboarding household appliance 2 (block 230);
   check whether the received response to the challenge is valid (block 240); and
   authenticate the onboarding household appliance 2 if the received response to the challenge is determined to be valid (block 250);
and the onboarding household appliance 2 is programmed to:
   receive the encrypted challenge (block 260);
   decrypt the encrypted challenge using its cryptographic private key (block 270);
   compute a response (block 280); and
   send the response to the assisting household appliance 4 (block 290).

In one embodiment, the challenge from the assisting household appliance 4 may be a random number, which is to be returned as a response by the onboarding household appliance 2 to the assisting household appliance 4, where it is checked to match with the one transmitted to the onboarding household appliance 2. The response may also be in the form of a number computed based on the random number and a proprietary algorithm.

During operation, a customer can run the mobile application on their mobile terminal 6, which responsively starts the automatic onboarding of the onboarding household appliance 2 to the network 3 with the assistance of one of the customer's household appliances 4 already connected to the WLAN 3. In particular, the mobile application causes an onboarding trigger command to be transmitted to the cloud system, which responsively transmits an onboarding request to all the customer's household appliances 4 already connected to the WLAN 3 and one of them responsively authenticate the onboarding household appliance 2.

In a different embodiment, the customer's household appliances 4 already connected to the WLAN 3 are programmed to periodically search for an additional smart household appliance 2 to be assisted in onboarding to the WLAN 3.

When the assisting household appliance 4 receives an onboarding assistance request from the onboarding household appliance 2, the assisting household appliances 4 is programmed to request the costumer to authorize the automatic onboarding of the onboarding household appliance 2 to the WLAN 3 by the assisting household appliance 4. The request may be communicated to the costumer via a control panel of the assisting household appliance 4 and/or via the customer's mobile terminal 6.

When the costumer authorizes the onboarding configuration, the assisting household appliance 4 starts to assist the onboarding household appliance 2 by performing the above-described authentication of the onboarding household appliance 2.

In a different embodiment, the assisting household appliance 4 is programmed to either establish a connection with, or send a connectionless message to, the onboarding household appliance 2 in response to an onboarding authorization command received from a seller of the onboarding household appliance 2 and generated and transmitted to the assisting household appliance 4 in response to the onboarding household appliance 2 being registered to a customer's account.

The customer account may be indexed e.g., with a customer's email account or phone number or any other unique combination, and during the registration of the onboarding household appliance 2 to the customer's account a product identification code, i.e., model, type, etc., and its serial number, which is supposed to be unique in the production of that specific model of onboarding household appliance 2, are to be provided, which are then linked to the customer account.

In this embodiment, when the onboarding household appliance 2 is authenticated, before providing the WLAN credentials to the onboarding household appliance 2, the assisting household appliance 4 may be further programmed to check that the product identification code and serial number provided during the registration of the onboarding household appliance 2 to the customer account match with stored ones associated with the customer account and to provide the WLAN credentials to the onboarding household appliance 2 if also this further check has a positive outcome.

From the foregoing, the technical advantages and the innovative features of the present invention may be easily appreciated by those skilled in the art.

In particular, the present invention allows to avoid the need of specific technical skills by the customer by implementing an auto-configuration process, wherein one of the following steps 1.a, 1.b, 1.c and the following step 2 are carried out:
1.a) simplification of the auto-configuration process with the support of the seller, which is compatible for e-commerce services and platforms;
1.b) requirement of one operation (i.e. select the “add device” function) on an app to onboard the onboarding household appliance 2 in case the onboarding is performed though a customer's mobile terminal 6;
1.c) requirement of one operation (i.e. select the “accept device” function) on the assisting household appliance 4 or a connected (via local or remote network) smart device 6; and
2.) authentication of the onboarding household appliance 2 as part of the same ecosystem or company products so that the assisting household appliances 4 already configured in the network 3 are not just sharing credentials with any household appliance but only with the trusted/recognized ones, such as the onboarding household appliance 2.

1. A system comprising:
a first household appliance; and
a second household appliance, wherein the second household appliance is configured to:
store network connection credentials, for connecting the second household appliance to the network;
receive an onboarding assistance request from the first household appliance, wherein the request comprises a unique identifier of the first household appliance;
retrieve a public cryptographic key of the first household appliance;
authenticate the first household appliance based on the unique identifier in the received onboarding assistance request, based on the public cryptographic key of the first household appliance, and based on an asymmetric cryptography authentication protocol; and
when the first household appliance is authenticated, provide the network connection credentials to the first household appliance; and
wherein the first household appliance (2) is configured to:
broadcast an onboarding request;
receive the network connection credentials from the second household appliance; and
connect to the network using the received network connection credentials.

2. The system according to claim 1, wherein in order to authenticate the first household appliance, the second household appliance is further configured to:
access a public cryptographic key database where public cryptographic keys of household appliances are stored in association with unique identifiers thereof to fetch out from the public cryptographic key database the public cryptographic key of the first household appliance stored in association with the unique identifier thereof; and
authenticate the first household appliance based on the public cryptographic key thereof fetched out from the public cryptographic key database and on the asymmetric cryptography authentication protocol.

3. The system according to claim 1, wherein in order to authenticate the first household appliance, the second household appliance is further configured to:
access a public cryptographic key database where values computed from public cryptographic keys of household appliances based on a one-way function that converts the public cryptographic keys to values representative of the public cryptographic keys are stored in association with unique identifiers of the household appliances, to fetch out from the public cryptographic key database the value computed from the public cryptographic key of the first household appliance stored in association with the unique identifier thereof;
communicate with the first household appliance to receive therefrom a stored public cryptographic key of the first household appliance;
compute a value from the public cryptographic key received from the first household appliance and based on the same one-way function based on which the value fetched out from the public cryptographic key database stored in association with the unique identifier of the first household appliance was computed from the public cryptographic key thereof;
check whether the value fetched out from the public cryptographic key database matches with the value computed from the public cryptographic key received from the first household appliance; and
if the stored value fetched out from the public cryptographic key database is determined to match with the computed value computed from the public cryptographic key received from the first household appliance, authenticate the first household appliance based on the public cryptographic key thereof received therefrom and on the asymmetric cryptography authentication protocol.

4. The system according to claim 1, wherein the second household appliance is configured to authenticate the first household appliance based on an asymmetric cryptography challenge-response authentication protocol.

5. The system according to claim 4, wherein, according to the asymmetric cryptography challenge-response authentication protocol, the second household appliance is configured to:
generate a challenge for the first household appliance;
encrypt the challenge with the public cryptographic key of the first household appliance;
send the encrypted challenge to the first household appliance;
receive a response from the first household appliance;
check whether the received response to the challenge is valid; and
authenticate the first household appliance if the received response to the challenge is determined to be valid; and
wherein the first household appliance is configured to:
receive the encrypted challenge;
decrypt the encrypted challenge using a cryptographic private key; and
compute and send the response to the second household appliance.

6. The system according to claim 1, wherein the onboarding assistance request is broadcasted by the first household appliance in response to detecting an assistance availability advertisement broadcasted by the second household appliance advertising its availability to assist the first household appliance in onboarding to the network.

7. The system according to claim 1, wherein the onboarding assistance request is broadcasted by the first household appliance in response to receiving an onboarding trigger command from a customer's mobile terminal in communication with the first household appliance.

8. The system according to claim 7, wherein the onboarding trigger command is generated by the customer's mobile terminal in response to either a customer's trigger gesture on the customer's mobile terminal or a customer-uttered trigger voice command.

9. The system according to claim 1, wherein the second household appliance is configured to become authorized to assist the first household appliance in onboarding to the network by an onboarding authorization command received from one of or both a control panel of the second household appliance and a customer's mobile terminal directly or indirectly connected to the second household appliance.

10. The system according to claim 1, wherein the second household appliance is configured to become authorized to assist the first household appliance in onboarding to the network by an onboarding authorization command received from either a seller of the first household appliance or a cloud system and generated in response to the first household appliance being registered to a customer's account.

11. (canceled)

12. A method for onboarding a household appliance to a network, comprising the steps of:
broadcasting, by a first household appliance, an onboarding assistance request containing a unique identifier of the first household appliance;
receiving, in a second household appliance, the onboarding assistance request;
retrieving, by the second household appliance, a public cryptographic key of the first household appliance based on said unique identifier;
authenticating, in the second household appliance, the first household appliance based on said public cryptographic key and on an asymmetric cryptography authentication protocol;
after authenticating the first household appliance, sending network connection credentials of the second household appliance to the first household appliance; and
connecting the first household appliance to the network using the network connection credentials of the second household appliance.

13. The method of claim 12, wherein retrieving a public cryptographic key of the first household appliance comprises:
accessing, by the second household appliance, a public cryptographic key database where public cryptographic keys of household appliances are stored in association with unique identifiers thereof, and
identifying, in the public cryptographic key database, the public cryptographic key associated with said unique identifier of the first household appliance.

14. The method of claim 12, wherein
retrieving a public cryptographic key of the first household appliance comprises:
accessing, by the second household appliance, a public cryptographic key database where values computed from public cryptographic keys of household appliances based on a one-way function are stored in association with unique identifiers of the household appliances, and
identifying in said database a first value computed from the public cryptographic key of the first household appliance; and
authenticating the first household appliance comprises:
sending from the first household appliance to the second household appliance a public cryptographic key of the first household appliance;
computing, in the second household appliance, a second value from the public cryptographic key received from the first household appliance based on said one-way function;
checking whether the first value matches with the second value; and
if the first value matches with the second value, authenticating the first household appliance based on the public cryptographic key received therefrom and on the asymmetric cryptography authentication protocol.
